(19) United States
(12) Patent Application Publication
(10) Pub. No.: US 2025/0392575 A1
(43) Pub. Date: Dec. 25, 2025

(54) METHOD AND MODULE FOR DYNAMIC ROUTING MODIFICATION

(71) Applicant: Orange, Issy-les-Moulineaux (FR)

(72) Inventors: Laurent VALEYRE, CHATILLON CEDEX (FR); Frédéric FIEAU, CHATILLON CEDEX (FR); Gaël FROMENTOUX, CHATILLON CEDEX (FR)

(21) Appl. No.: 19/242,721

(22) Filed: Jun. 18, 2025

(30) Foreign Application Priority Data
Jun. 20, 2024 (FR) FR2406615

(51) Int. Cl. H04L 9/40

(52) U.S. Cl. CPC H04L 63/0281; H04L 63/0823; H04L 63/1425

(57) ABSTRACT

A method is proposed for routing modification in a service system of a communications network, the method comprising, during a direct communication between a first service and a second service: a conditional establishment of an indirect communication between said services, via an intermediary service. A corresponding module is also proposed.

### CROSS-REFERENCE TO RELATED APPLICATIONS

This application claims foreign priority to FR2406615, filed Jun. 20, 2024. The contents of each are incorporated by reference herein in its entirety.

### BACKGROUND

### Field

This disclosure relates to the field of telecommunications. It relates more specifically to a method for dynamic routing modification in a service system of a communication network, and to a corresponding module, device, computer program, and storage medium.

### Description of the Related Technology

The state of the art includes systems that use containerization technologies, such as Docker, and container orchestration technologies, such as Kubernetes.

These systems are designed to deploy applications and services to data processing agglomerations, or “clusters,” by distributing them across multiple work environments, or “clouds.”

In this context, there is a continuing need to allow the easy, hot insertion of additional functions affecting current traffic in service systems.

### SUMMARY

This disclosure improves the situation.

A method for routing modification in a service system of a communication network according to claim 1, and a module for routing modification in a service system of a communication network according to claim 13, are proposed. The dependent claims present preferred embodiments of the disclosure.

The method may be a method for dynamic routing modification in a service system of a communications network, the method comprising, during an active and direct communication between a first service and a second service:
a conditional establishment of an indirect communication between said services, via an intermediary service.

The method allows inserting intermediary functions, potentially on the fly, with no interruption of service, so that a stream routed by the system benefits from these intermediary functions. This flexibility allows maintaining a continuous communication between services while adding additional functionalities, which facilitates a rapid response to various needs, for example in security or performance. In particular, the method is able to improve the resilience and/or security of the communications network. Indeed, the conditional insertion of intermediary services allows all or part of traffic to be redirected through security services, such as firewalls or intrusion detection systems, thereby increasing protection against cyberattacks.

The module may be a module for dynamic routing modification in a service system of a communication network, the module being configured for the following, during an active and direct communication between a first service and a second service:
a conditional establishment of an indirect communication between said services, via an intermediary service.

According to another aspect, a computer program is provided comprising instructions for implementing all or part of a method as defined herein, in any of its embodiments, when this program is executed by a processor. According to another aspect, a non-transitory computer-readable storage medium is provided on which such a program is stored.

The features set forth in the following paragraphs may optionally be implemented, independently of one another or in combination with one another:

In one example, said conditional establishment takes into account a management policy of the service system.

This can facilitate intelligent and adaptive traffic management within the communications network. For example, in a scenario where the network must prioritize critical data traffic, the management policy may automatically redirect this traffic through a verification service to ensure its integrity and timeliness.

In one example, said conditional establishment takes into account a monitoring of traffic within the communications network.

This provides the service system with a capability for a real-time response to detected anomalies or attacks. For example, when a traffic anomaly is detected, indicating a potential DDOS attack, the suspicious traffic may be automatically redirected to an analysis service to neutralize the threat.

In one example, the intermediary service acts as a service for the at least partial repair of traffic originating from the first service.

This helps increase the quality and reliability of communications, particularly critical communications, by enabling real-time data stream repair. If corrupted packets are detected in a transmission, the intermediary service may thus correct these packets before transmitting them to the final recipient without interrupting the transmission, thereby improving the user experience.

In one example, the intermediary service is selected among a plurality of services during said conditional establishment.

Choosing the most appropriate service among several available options represents an advantage in terms of flexibility. For example, for a streaming service, different caching services may be used depending on the users' geographical location, to optimize latency and load speed.

In one example, the intermediary service is selected based on at least one selection criterion among:
a required security level,
a required performance level,
a type of traffic using indirect communication,
a regulatory requirement;
a combination of at least two of the above criteria.

At least one (for example each) selection criterion may be aligned with a specific operational requirement and may, for example, take into account the aforementioned management policy and/or the aforementioned monitoring, thereby enabling increased flexibility and responsiveness.

In one example, the above method (or module) is implemented by a WASM (WebAssembly) module.

The WebAssembly format inherently ensures high performance and cross-platform compatibility, facilitating the deployment and execution of the intermediary function regardless of the hardware and software medium used on the servers and relevant terminals.

In one example, the above method (or module) is implemented in a container environment.

This facilitates the integration and management of intermediary functions in microservices architectures, thus helping to provide improved scalability and portability.

In one example, the intermediary service is dynamically deployed during said conditional establishment.

Such an approach can help improve the responsiveness of the service system by enabling the instantaneous (or near-instantaneous) deployment of new intermediary functions. For example, during an urgent security update, a new filtering service may be deployed on the fly, to protect the network immediately against a new vulnerability.

In one example, the above method comprises (or the above module is configured for) an abandonment of the direct communication upon establishment of the indirect communication.

This can help increase system security (towards maximum security) by ensuring that all traffic passes through the intermediary function, without exception. For example, for financial transactions, direct communication may be abandoned in favor of communication via an authenticity verification service, to prevent fraud.

In one example, the above method comprises (or the above module is configured for) a conditional abandonment of the indirect communication after the indirect communication has been established.

Providing for the reestablishment of direct communication when security or performance conditions so permit is one possible option to help optimize the resources of the service system.

In one example, the above method comprises (or the above module is configured for) an application of an authentication and/or filtering overlay to the indirect communication.

Such mechanisms contribute to strengthening the security of communications. For example, in a corporate network, it may be provided that all communications passing through a given intermediary service are authenticated and filtered to prevent unauthorized access and data exfiltration.

### BRIEF DESCRIPTION OF THE DRAWINGS

Other features, details and advantages will become apparent from reading the detailed description below, and from analyzing the attached drawings, in which:

FIG. 1 shows an algorithm and a functional organization of a service system in one exemplary implementation.

FIG. 2 shows an architecture of a control plane of a service system in one exemplary implementation.

FIG. 3 and FIG. 4 show two examples of the establishment of an indirect communication between two services, in exemplary implementations.

### DETAILED DESCRIPTION OF CERTAIN ILLUSTRATIVE EMBODIMENTS

In the following description, identical reference numbers designate identical elements or elements having similar functions.

This disclosure relates to a technique for supporting a service system deployed in a communications network.

It should be pointed out as an introductory note that the term “service” is used in general in this document to encompass an actual service, one or more microservices, or even a complete application. An “application” is understood to mean a set of software functionalities or macro-functions that meet a specific need. An application may be composed of one or more services or microservices that work together to provide the overall functionality. It should be noted that the distinction between a “service” and a “microservice” is primarily based on the scale and the functional subdivision of an application's software architecture. A service is a self-contained functional unit that can cover a broad set of functionalities and may either form part of a larger application or may be used by multiple applications. A microservice is smaller, and is generally responsible for one specific functionality of an application.

One aspect of the technique proposed in this document is a method for dynamic routing modification in a service system of a communications network.

Another aspect of the proposed technique is a module for dynamic routing modification in a service system of a communications network.

Any suitable hardware and/or software means may be used for the actual implementation of said module and/or said services. For example, a Packet Gateway (PGW) is one example of a network device providing a data routing service that includes security functions. In general, although some aspects of the proposed technique may be described in this document as a process, device, module, system, procedure, or method, it should be noted that the proposed technique may also cover a computer memory capable of being connected to a processor possibly connected to a communications interface, the memory storing instructions which, when executed by such a processor, allow implementing the processes, devices, modules, systems, procedures, or methods described in this document.

Some terms specific to service systems and to communications networks are now clarified, for a better understanding of the proposed technique.

The term “service system” refers, in the context of this document, to a physical and/or software medium that enables communication and the sharing of resources and services in a communications network. This system may refer to a communications infrastructure or one or more of its sub-parts, including data processing and storage systems, servers and networks, data centers, cloud systems, telecommunications equipment, etc. This system may also relate to a communications infrastructure within a specific organization, such as an internal network of computers and servers, or to a broader infrastructure, such as a telecommunications network or a cloud. The proposed technique is applicable to any type of service system and to any type of network architecture.

A service system comprises a set of resources capable of being reserved for the operation of one or more services. This set of resources may include resources of various types, including computing time in one or more processors, locations of one or more memories, or even usage slots, expressed for example as time and/or frequency slots, of one or more communication channels.

A service system may extend across multiple sites and benefit from the efficiency of a multi-site architecture. Such architectures are well established and allow for increased robustness and resource management across the entire service system. Distributed edge architectures represent a further development that is particularly relevant for telecommunications systems such as Cloud-RAN, where they are currently being deployed.

Cloud computing environments rely on one or more service systems as defined above.

In cloud computing environments, the basic host unit is often called a “container.” These containers are lightweight software units that encapsulate code and all its dependencies, allowing a service to run reliably from one computing environment to another.

To manage these containers, a solution known as Kubernetes, K8S, is frequently employed. Kubernetes is a system that facilitates the deployment, scaling, and management of containerized services.

In the Kubernetes architecture, containers are grouped into “pods,” which are the basic unit representing a deployment of a service. Multiple pods can be grouped into a “node,” which symbolizes a server. The definition of “node” in the Kubernetes architecture corresponds to that of “node” in the NUMA system. These nodes are then grouped into “clusters,” which are sets of servers that work together and can be thought of as a single system.

In the context of Kubernetes, a cluster is composed of a group of “Masters” and Nodes. Masters are the components of the Kubernetes cluster that provide the control interface or control plane for the cluster, and manage pod scheduling, failure detection and management, and the deployment of new application versions. Nodes, on the other hand, are the servers that run the applications and provide the runtime environment for the containers.

To manage network communications between the containers of an application deployed on a Kubernetes cluster, auxiliary containers known as “sidecar proxies” are attached to each of the application's main containers. Sidecar proxies are responsible for intercepting and managing network communications. Each sidecar proxy acts as an intermediary between the main container to which it is attached and the rest of the network. To enhance security, sidecar proxies may include functions such as request and response validation, authorization and identity management, and monitoring.

ISTIO is an example of an open-source service mesh commonly used by networking and security operators to run distributed microservice-based applications. It provides a uniform way to connect, manage, and secure these microservices using sidecar proxies.

ISTIOD is a central pilot for ISTIO, which serves as a control point for configuring sidecar proxies. It is adapted for managing routing rules, a policy for managing communications and operations between services, and service configurations. ISTIOD intervenes in event detection by enforcing policy and observing communications between microservices.

KIALI is a visualization tool for ISTIO that allows visually identifying anomalies or unusual behavior patterns in communications between microservices. KIALI thus facilitates the detection of events related to potential security issues.

JAEGER is a distributed traceability system, which allows collecting information on communications between microservices in order to enable a detailed analysis of latency, performance, and errors. JAEGER thus facilitates the detection of events related to performance issues or failures.

The proposed technique is particularly suitable for microservice architectures, such as containers and virtual network functions. These are commonly used in telecommunications systems and cloud-based computing environments.

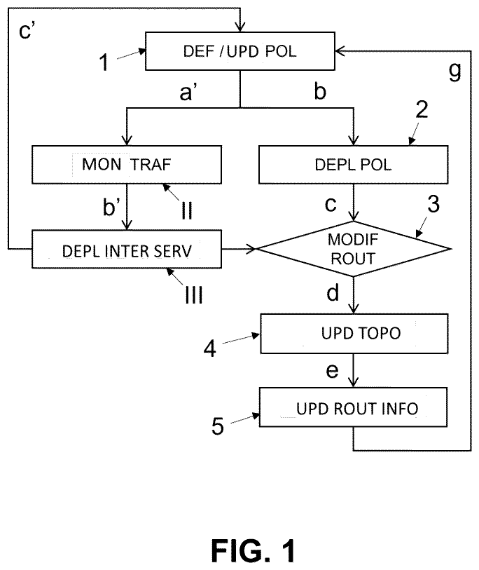

We now refer to FIG. 1, which represents one possible example of an algorithm and a functional organization enabling the implementation of the proposed technique at the service system level in a communication network.

In a first possible branch in the algorithm, the following are provided:
a management policy definition and update module 1,
a management policy deployment module 2,
a traffic routing modification module 3 for the traffic concerned by the management policy and/or by the monitoring,
a topology information update module 4, and
a routing information update module 5.

The management policy definition and update module 1 is configured to establish and/or revise a traffic management policy within the network. This policy may relate to optimizing one or more needs, for example security, performance, or availability. The module 1 may define rules that determine how the other modules must manage and direct traffic. The module 1 may further provide that application of a given rule is differentiated by entity (for example a service, a client, a macro-function) or by group of entities, for example based on the respective criticality levels of the entity or group of entities concerned.

The management policy deployment module 2 is configured to deploy the policy established or updated by module 1 to the network in order to be applied in real time.

The traffic routing modification module 3 is configured to enforce the management policy by modifying, if necessary, one or more routes that the traffic must follow through the network. This may include activating security features based on various triggers such as changes in traffic volume, specific user-defined priorities, or quality of service criteria (predefined for example). For example, a sudden increase in traffic volume or a demand for a high service priority may conditionally activate firewalls or intrusion detection systems to preemptively enhance security within the network. Conditional activation of these security features therefore does not require prior detection of a specific event. “Specific event” is understood to mean incidents such as a detected intrusion attempt, a security alert generated by a monitoring system, or a reported hardware failure. The triggers may thus include scenarios such as:
an increased demand for bandwidth due to a planned event (e.g. a live broadcast),
network reconfiguration to optimize performance during peak hours, the application of enhanced security policies for critical network segments, or
routing adjustments to maintain quality of service during updates or maintenance to certain parts of the network.

The topology information update module 4 is configured to maintain and update the network map. This update contributes to routing optimization and to the efficient distribution of service system resources. Module 4 may be configured to update topology information in a schedule that is differentiated by service, stream, or client, based on the criticality of the service, stream, or client in question. In addition to a conditional routing modification implemented by module 3, it may be provided that module 4 is configured to implement a conditional update of entry points into the network, to reinforce the corresponding accesses to the network.

The routing information update module 5 is configured to ensure that the information about routes and/or traffic paths within the network is continuously up to date, thus helping to increase responsiveness to any adjustment to the management policy, an update of the new network architecture including eliminated services and/or new deployments for example, or an implementation of cleaning operations for the purpose of optimizing service system resources. For example, the responsiveness may be immediate or almost immediate.

Modules 1 to 5 interact in a cycle represented in FIG. 1 by arrows b, c, d, e, and g.

Arrow b represents the transfer of the traffic management policy defined or updated by Module 1 to Module 2. This arrow symbolizes the transmission of the complete guidelines and rules to be deployed in the network. This includes all changes made to traffic, security, and performance management, as well as specifications on how the policy is to be applied according to the different criticality levels of the entities involved.

Arrow c transmits the management policy deployment instructions from Module 2 to Module 3. This includes specific guidelines on the routing changes required in order to apply the management policy in the network, including the conditional activation of security features or other measures without the presence of a specific trigger.

Arrow d carries information about routing changes made by Module 3, to Module 4. It communicates adjustments or new route configurations that require updating in the network map so that Module 4 can update and optimize the network topology accordingly.

Arrow e carries updated topology information from module 4 to module 5. It is used to inform the routing information update module about the latest network topology changes, thus allowing these changes to be reflected in current traffic routes in order to maintain network efficiency.

Arrow g represents the feedback from Module 5 to Module 1. This feedback includes data on current routing efficiency and any other relevant indicators that could influence the future traffic management policy. This feedback allows Module 1 to re-evaluate and refine the existing policy, to better meet changing network needs.

The first branch of the algorithm in FIG. 1 allows dynamically adding functionality to a pre-existing stream; it may be applied in various contexts of use.

For example, for the purpose of dynamic network capacity management, it allows using a traffic management policy to adjust network routing and capacity automatically. This is done by setting up intermediary functions based on fluctuating demand, thus ensuring optimal performance without human intervention.

For example, for the purpose of proactively responding to a vulnerability, it allows conditionally activating security features such as firewalls or intrusion detection systems, based on a security policy that is continually revised to counter emerging threats before an attack occurs.

For example, for the purpose of improving (e.g. optimizing) the user experience for critical applications, it allows for routing adjustments by setting up intermediary functions to help improve the quality of service for latency-sensitive applications, such as VoIP or video streaming services, reducing delays and limiting (e.g. avoiding) network congestion.

A second possible branch of the algorithm is provided, in addition to modules 1, 3, 4, and 5 described above:
a traffic monitoring module II, and
an intermediary service deployment module III.

An additional module for the provisional implementation of an infrastructure supporting said intermediary service may also be provided, prior to implementing module III, in order to enhance the responsiveness of the algorithm

The traffic monitoring module II is configured to monitor network traffic continuously, i.e. on a regular and uninterrupted basis, with inspection frequencies and methods that may vary depending on specific network needs and/or specific service system management objectives. For example, it may be provided that certain types of traffic or network segments (more critical, for example) are monitored more intensively. This monitoring may include, for example, one or more of the following monitoring methods:
a comprehensive inspection of each data packet originating from the first service, or of each packet circulating between the first and second services,
a random inspection of data packets originating from the first service, or of packets circulating between the first and second services,
a periodic inspection, at regular intervals, of data packets originating from the first service, or of packets circulating between the first and second services,
a collection of network performance metrics such as traffic volume, error rate, or latency, coupled with an analysis of these metrics over a sufficiently long period to identify unusual trends or sudden jumps or drops in traffic volume that could indicate security or performance issues,
a use of anomaly detection algorithms that evaluate the data continuously collected by the proxies in order to identify suspicious behaviors as deviations from (“normal”) behaviors expected by the management policy, a suspicious behavior referring, for example, to a sequence of requests that do not match a normal usage profile or a high rate of errors or abnormal responses detected by proxies,
monitoring based on specific events or predefined triggers, such as security alerts, network configuration changes, or signatures of cyberattacks by applying the management policy.

These monitoring methods are complementary, and potentially may be used together.

An example of an attack detection algorithm that may be implemented by a WASM module may include detecting a user associated with a given traffic, then implementing one or more filtering rules based on user authentication, then analyzing the frames of the given traffic. Such an algorithm allows analyzing the given traffic according to several criteria reflecting a specific attack signature, for example traffic origin, traffic destination, traffic destination port, traffic throughput variation, etc.

It may for example use sensors and advanced algorithms to collect metrics or indicators which allow evaluating traffic patterns in real time in terms of, for example, security, performance of deployed services, resource utilization and/or energy consumption rates, detecting deviations from a standard that could indicate security risks and/or failures, and/or generating alerts based on the detected deviations.

The intermediary service deployment module III is configured to react to alerts generated by module II, by deploying (quickly for example) one or more intermediary services for inspecting, filtering, and/or modifying traffic in order to manage detected threats. This module allows acting specifically on data streams that are deemed at risk without disrupting the entire network. For example, it may be provided that module III deploys the intermediary service on specifically identified and/or selected cloud resources, for example one or more pods, nodes, or clusters.

Modules 1, II, III, 3, 4 and 5 interact in a cycle indicated in FIG. 1 by the arrows a′, b′, d, e and g, which represents an implementation of a countermeasure to a detected attack, relying on a control plane of the service system.

Arrow a′ represents the transfer of the traffic management policy defined or updated by Module 1 to Module II. This arrow symbolizes, similarly to arrow b described above, the transmission of the complete guidelines and rules that are to be deployed in the network. This includes guidelines relating to traffic monitoring by Module II and in particular may include values (used for example as thresholds) or standards as references to which to compare the collected metrics or indicators relating to the current traffic.

Arrow b′ represents the transmission of security alerts and notifications of abnormal or undesirable behavior detected by Module II, to Module III. These alerts trigger the deployment of intermediary services to address or mitigate identified risks as well as routing modifications by Module 3 to direct all or part of the traffic affected by these identified risks to these intermediary services.

Arrows d, e, and g perform the same functions as those described above in relation to the first branch, i.e. the transfer of routing update, topology update, and feedback information in order to allow the ongoing management and/or the re-evaluation of the management policy.

The second branch of the algorithm in FIG. 1 allows for intercepting and so-called “strong” processing of a pre-existing stream; it may be applied in various contexts of use.

For example, for the purpose of rapid detection and intervention in the event of a cyberattack, it allows detecting an intrusion attempt or malicious traffic in real time and automatically deploying security functions (e.g. by encrypting the data involved and/or protecting and/or isolating the application concerned) to inspect and neutralize the attack before it reaches critical assets.

For example, for the purpose of managing traffic anomalies in networks involving connected objects, it allows specifically monitoring the connected objects to detect abnormal behavior that could indicate a compromised connected object, and, if necessary, to intervene immediately (or almost immediately) to secure the data and the connected objects concerned.

For example, for the purpose of dynamic control of applications in a hybrid cloud environment, it allows, in the event that an abnormally high or suspicious workload is detected in the cloud, automatically isolating the application concerned and redirecting traffic to more secure resources for further examination, thus ensuring the continuity and security of operations.

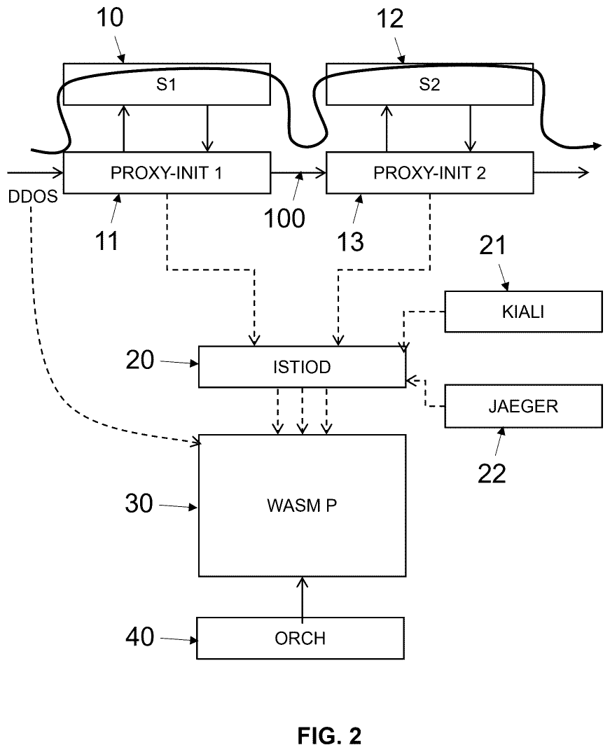

We now refer to FIG. 2, which represents one possible example for the architecture of a control plane which allows implementing the proposed technique in a communication network at the service system level. Generally, a suitable control plane comprises at least one manager, one orchestrator, and one service mesh (in this case ISTIO in the illustrated example).

In the service system, all network traffic is successively directed to a plurality of services according to the principle of service chaining.

In FIG. 2, an example of network traffic is symbolized as first being directed to a first service 10 and then to a second service 12.

Sidecar proxies 11, 13 are respectively configured for each service 10, 12. These proxies route the traffic through the service system. Thus, in the example considered, the incoming traffic is first directed to proxy 11 of first service 10, then routed by proxy 11, in the form of a communication 100, to proxy 13 of second service 12.

The proxies are managed centrally by an ISTIOD module 20, which itself able to use a KIALI module 21 and/or a JAEGER module 22, at least to assist with decision-making. The KIALI module 21 allows visualizing the impact and extent of a detected event (for example an attack) on the entire service system, thus facilitating rapid decision-making regarding routing and/or topology modifications to be made. The JAEGER module 22 allows the request path to be tracked through the various microservices, which makes it easy to analyze the impact of recent routing and/or topology changes on the operation of the service system and to identify potential points of failure or bottlenecks, thereby facilitating decision-making regarding corrective actions.

The ISTIOD module 20 is interfaced with a service system orchestrator 40 and/or a service system manager (not shown) via a dedicated module or plugin 30, for which the setup and/or updating are, for example, carried out by the management policy deployment module 2. For example, module 30 may be a WebAssembly module (WASM). WebAssembly is a binary format and a low-level language designed to be executed in web browsers. It enables the execution of complex and high-performance web applications, offering an alternative to traditional programming languages such as JavaScript. WebAssembly is also used outside of web browsers, particularly in terminals. It allows applications and software to be executed in a portable and secure manner on different types of terminals, such as smartphones, tablets, desktop computers, servers, etc. WebAssembly can enable high performance and cross-platform compatibility, making it an attractive choice for the development of terminal applications.

The traffic data passing through the proxies 11, 13 may thus be analyzed by module 30 in order to detect attack signatures, such as traffic anomalies, suspicious access patterns, or malware signatures. Module 30 may be configured to react to specific criteria applicable to given traffic, or to all traffic associated with a given client, a given service, a given criticality level, etc., or to all traffic within the service system. Examples of specific criteria include throughput thresholds, request types, or user behaviors.

When an event (such as a potential attack) is detected by module 30, it may be provided that the orchestrator 40 and/or the service system manager are instructed to modify the routing dynamically in order to isolate or redirect traffic to specialized services, such as a “clinic” service to further clean and/or inspect the traffic. This may include redirection through secure paths or services that provide additional cleaning and/or authentication functions. For example, establishing a secure path to an intermediary service may involve an exchange of TLS certificates.

The intermediary service may be implemented by a service provider. Provision may also be made to notify the service provider, and more generally any entity concerned, of an alert indicative of the detected event: said entity being for example a certifier or any other relevant entity of the control plane, clients of one or more applications concerned by the detected event, etc. After analyzing the alert and/or the traffic redirected to the intermediary service, the service provider may select one or more appropriate functions from a library of functions that can be performed by the intermediary service. The intermediary function may be provided, for example, in the form of ad hoc WASM code, which may possibly be generated on the fly by the service provider, or in the form of a cloud resource, such as a pod, hosting such code.

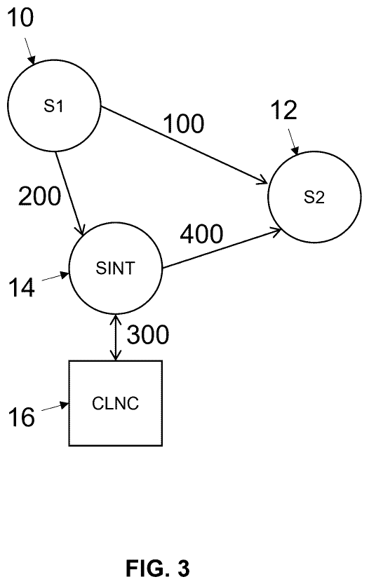

FIG. 3 illustrates an example of the establishment of an indirect communication between the first service 10 and the second service 12, via an intermediary service 14 acting as a partial repair service for the traffic initially directed from the first service to the second service.

In the example of FIG. 3, the initial direct communication 100 between the respective proxies 11, 13 of the first and second services remains active for a portion of the traffic initially directed from the first service to the second service via said direct communication (for example, traffic considered not indicative of an attack), while the remaining portion of the traffic (for example, traffic considered indicative of a potential attack) is diverted to the intermediary service 14.

The indirect communication comprises:
a first communication 200 between the proxy 11 of the first service and the proxy of the intermediary service 14,
followed by an internal communication 300 within the intermediary service 14 to a so-called “clinic” module providing an inspection and/or repair function for the traffic received by the intermediary service 14, and
a second communication 400 between the proxy of the intermediary service and the proxy 13 of the second service.

The indirect communication may be established in two stages. In a first stage, the first communication 200 and the second communication 400 may be prepared, meaning that the corresponding routes may be defined at the control plane of the service system without being immediately used to transport any stream. Then, in a second stage, the prepared routes may be activated, i.e. used to direct the traffic from the proxy 11 of the first service to the proxy of the intermediary service 14, then from the proxy of the intermediary service 14 to the proxy 13 of the second service. Activation of the routes may be carried out according to a weight setting. For example, before activation, a weight of 1 may be assigned to the route corresponding to the direct communication 100 while a weight of 0 may be assigned to the route corresponding to the first communication 200; thus all traffic processed by the first service is directly routed to the second service. Activating indirect communication may include assigning a weight “x”, such that 1≥x>0, to the route corresponding to the first communication 200, and simultaneously assigning a weight “1−x” to the route corresponding to the direct communication 100. Thus, depending on the chosen value of “x”, all or part of the traffic processed by the first service is directly routed to the intermediary service.

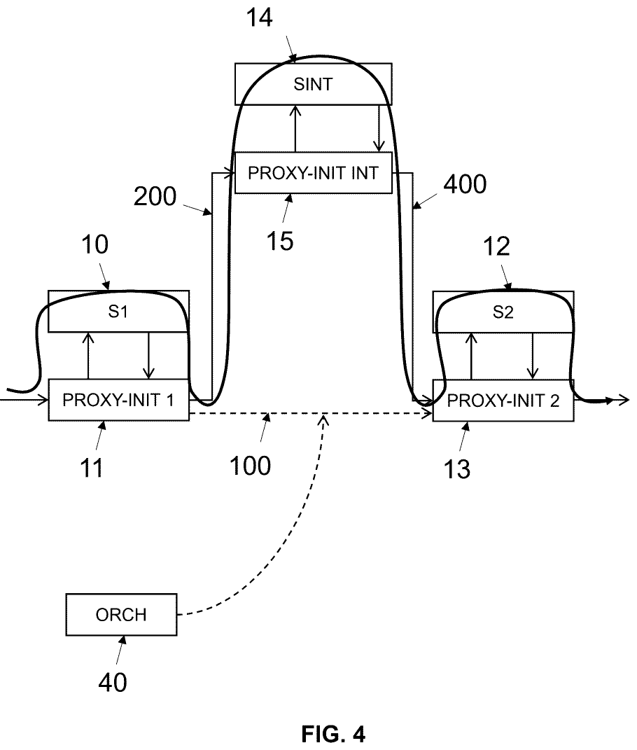

FIG. 4 illustrates another example of the establishment of an indirect communication between the first service 10 and the second service 12, via an intermediary service 14.

In the example of FIG. 4, the direct communication 100 is deactivated and is replaced by:
the first communication 200 between the proxy 11 of the first service and the proxy 15 of the intermediary service 14,
the second communication 300 between the proxy 15 of the intermediary service and the proxy 13 of the second service.

It is clear from the exemplary embodiments described above that the direct communication according to the disclosure may be based on an established or preconfigured link. This link may be active, inactive, or dormant at the time of examination of at least one condition leading to the establishment of the indirect communication.

### INDUSTRIAL APPLICATION

These technical solutions may apply for operators and businesses wishing to strengthen the security of their applications and services operating in environments based on containers and microservices.

They may be adapted in particular, at least in certain embodiments, for the management of service systems within cloud computing environments, whether private ones or hybrid ones combining private and public elements.

They may be adapted, at least in certain embodiments, to participate in the protection of databases, whose access points often constitute vulnerabilities (and sometimes even play a key role in this protection). Although these databases are located in highly secure locations, they are frequently accessed via infrastructures shared between private and public domains, which may present risks.

These solutions may be adapted in particular, at least in certain embodiments, to various cluster configurations, whether located at a single site or distributed over several sites and managed by different actors, as in the case of Cloud-RAN configurations.

Example applications may involve a wide variety of systems and infrastructures, for example clusters operated by multiple actors, distributed over different geographical areas, and extended across several data centers, or a main cluster with replicas distributed across several data centres, or even multi-actor and multi-zone clusters connecting satellites to terrestrial data centres.

This disclosure is not limited to the examples described above solely by way of example, but encompasses all variants conceivable to a person skilled in the art within the framework of the protection sought.

What is claimed is:

1. A method for routing modification in a service system of a communications network, the method comprising, during a direct communication between a first service and a second service:
a conditional establishment of an indirect communication between said services, via an intermediary service.

2. The method of claim 1, wherein said conditional establishment takes into account a management policy of the service system.

3. The method of claim 1, wherein said conditional establishment takes into account a monitoring of traffic within the communications network.

4. The method of claim 1, wherein the intermediary service acts as a service for the at least partial repair of traffic originating from the first service.

5. The method of claim 1, wherein the intermediary service is selected among a plurality of services during said conditional establishment.

6. The method of claim 1, wherein the intermediary service is selected based on at least one selection criterion among:
a required security level,
a required performance level,
a type of traffic using indirect communication,
a regulatory requirement,
a combination of at least two of the above criteria.

7. The method of claim 1, wherein the method is implemented by a WASM (WebAssembly) module.

8. The method of claim 1, wherein the method is implemented in a container environment.

9. The method of claim 1, wherein the intermediary service is dynamically deployed during said conditional establishment.

10. The method of claim 1, further comprising an abandonment of the direct communication upon establishment of the indirect communication.

11. The method of claim 1, further comprising a conditional abandonment of the indirect communication after the indirect communication has been established.

12. The method of claim 1, further comprising an application of an authentication and/or filtering overlay to the indirect communication.

13. A module for routing modification in a service system of a communication network, the module being configured for the following, during a direct communication between a first service and a second service:
a conditional establishment of an indirect communication between said services, via an intermediary service.

14. A computer program comprising instructions for implementing all or part of the method according to claim 1, when this program is executed by a processor.
